(19) United States
(12) Patent Application Publication
(10) Pub. No.: US 2022/0391960 A1
(43) Pub. Date: Dec. 8, 2022

(54) ELECTRIC VEHICLE CONDITION REPORTING

(71) Applicant: Recurrent Motors Inc., Seattle, WA (US)

(72) Inventors: Scott Parker Case, Tacoma, WA (US); Blake R. Hough, Friday Harbor, WA (US); Brian Scott Gerwe, Seattle, WA (US); Brigid Mary Dotson, Seattle, WA (US); Kyle David Rippey, Seattle, WA (US); Yugala Priti Wright, Seattle, WA (US); Meghana Reena Hebel, Seattle, WA (US)

(73) Assignee: Recurrent Motors Inc., Seattle, WA (US)

(21) Appl. No.: 17/833,896

(22) Filed: Jun. 7, 2022

Related U.S. Application Data
(60) Provisional application No. 63/197,871, filed on Jun. 7, 2021.

(51) Int. Cl. G06Q 30/06; G07C 5/08

(52) U.S. Cl. CPC G06Q 30/0627; G07C 5/0816

(57) ABSTRACT

A network-enabled system that provides condition reports, such as battery condition reports, for electric vehicles is disclosed. Specific embodiments implement superior techniques for enhancing the accuracy of the condition reports. In one preferred embodiment, a user is prompted to enter data about a specific vehicle which may be captured or verified using a photograph captured of certain data displays in or on the vehicle

### CROSS REFERENCE TO RELATED PATENT APPLICATIONS

This patent application claims the benefit of and priority to U.S. Provisional Patent Application Ser. No. 63/197,871, filed on Jun. 7, 2021, the disclosure of which is hereby incorporated by reference in its entirety for all purposes.

### SUMMARY WITH BACKGROUND INFORMATION

Electric vehicles are increasingly gaining in popularity as one effective mechanism to reduce greenhouse gas emissions and improve the environment. As the performance and reliability of the electric vehicle (“EV”) improves, once-skeptical consumers are making the transition from fossil-fueled vehicles to EVs in ever increasing numbers. However, with the paradigm shift away from fossil-fueled vehicles to EVs comes a new set of criteria that must be considered by consumers when making purchasing decisions. No longer are EVs compared by gas mileage; instead, they are compared by expected range per battery charge. In addition, the number of miles that a vehicle has travelled—which is a key criteria when evaluating a fossil-fueled vehicle—becomes less relevant than the expected health of the batteries in the EV. In addition, maintenance schedules based on miles travelled, which are of utmost importance for a fossil-fueled vehicle, are less relevant for an EV than other factors, such as the number of charging cycles that the EV has experienced. These and other examples illustrate the new difficulties of evaluating whether to purchase an EV, especially a used EV from a previous owner. New mechanisms are needed for evaluating and reporting the condition of an EV.

To address these issues, a network-enabled system that provides condition reports for electric vehicles is disclosed. In one specific example, a condition report provides a user with a computation of the condition of an EV's batteries. Specific embodiments implement superior techniques for enhancing the accuracy of the condition reports. In one preferred embodiment, a user is prompted to enter data about a specific EV which may be verified using a photograph captured of certain data displays in or on the vehicle. Alternatively, the photograph may itself be used to provide the data.

### BRIEF DESCRIPTION OF THE SEVERAL VIEWS OF THE DRAWINGS

Embodiments of the disclosure are best illustrated by way of example and not by way of limitation in the figures of the accompanying drawings, briefly described below, in which like reference numerals indicate similar elements. It should be noted that references to “an” or “one” embodiment in this disclosure are not necessarily to the same embodiment, and those terms mean at least but not necessarily one.

FIG. 1 illustrates a network environment in which embodiments of the disclosure may be implemented.

FIG. 2 illustrates one example display that may be presented by an implantation of the disclosure, in accordance with one embodiment.

FIG. 3 illustrates another example display that may be presented by an implantation of the disclosure, in accordance with one embodiment.

FIG. 4 illustrates yet another example display that may be presented by an implantation of the disclosure, in accordance with one embodiment.

FIG. 5 illustrates still another example display that may be presented by an implantation of the disclosure, in accordance with one embodiment.

FIG. 6 illustrates still another example display that may be presented by an implantation of the disclosure, in accordance with one embodiment.

FIG. 7 illustrates still another example display that may be presented by an implantation of the disclosure, in accordance with one embodiment.

FIG. 8 illustrates still another example display that may be presented by an implantation of the disclosure, in accordance with one embodiment.

FIG. 9 illustrates still another example display that may be presented by an implantation of the disclosure, in accordance with one embodiment.

FIG. 10 illustrates still another example display that may be presented by an implantation of the disclosure, in accordance with one embodiment.

FIG. 11 illustrates still another example display that may be presented by an implantation of the disclosure, in accordance with one embodiment.

FIG. 12 illustrates still another example display that may be presented by an implantation of the disclosure, in accordance with one embodiment.

FIG. 13 illustrates still another example display that may be presented by an implantation of the disclosure, in accordance with one embodiment.

FIG. 14 illustrates still another example display that may be presented by an implantation of the disclosure, in accordance with one embodiment.

### DETAILED DESCRIPTION

In the following detailed description, numerous specific details are set forth. However, it is understood that embodiments of the disclosure may be implemented without these specific details. In some instances, well-known components, structures, and techniques have not been shown to avoid obscuring an understanding of the disclosure.

Briefly stated, the disclosure teaches a system and method for evaluating and reporting on a condition of an EV in a manner that provides a consumer with a comparative metric that may be used in making a purchasing decision or maintenance decision for a specific EV. In one specific embodiment,

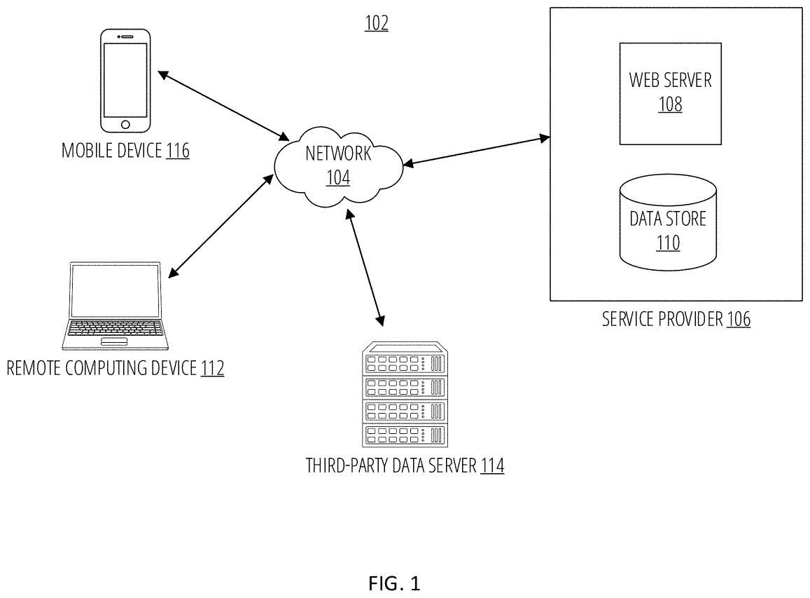

FIG. 1 is a conceptual diagram generally illustrating a computer network environment 102 in which embodiments of the disclosure may be implemented. The network environment 102 shown in FIG. 1 and described here identifies preferences and concepts to enable those skilled in the art to implement the teachings of this disclosure. Described here are only certain preferred embodiments, and many other embodiments will be apparent from a careful review of this disclosure.

As shown in FIG. 1, the network environment 102 includes at least a network 104, such as the Internet, and a service provider 106. The network environment 102 of the preferred embodiment further includes one or more remote computing devices 112 and may additionally include a third-party data server 114.

In one preferred embodiment, the service provider 106 is a network-accessible computer server that is specially programmed to provide condition reports, such as reports on the battery, range, or utility of electric vehicles (“EVs”). Various implementations are envisioned, but in general, the service provider 106 accepts requests for a condition report for a particular EV from a user, generates such report specifically for that particular EV, and returns the report to the requesting user.

To implement such features and functionality, the service provider 106 may incorporate a web server 108 component and a data store 110. The web server 108 component enables other computing devices, such as remote computing device 112, to interact and communicate with the service provider 106 over the network 104. The data store 110 enables the service provider 106 to store data locally which may be used by the service provider 106 to generate reports. In addition, the service provider 106 may use the data in the data store 110 to generate meta reports that can describe the condition of a group of EVs, such as a particular make, model, or configuration of EV. Such meta reports can be used to assess how well a specific EV compares to similar EVs, or to other EVs in the same geographic region (for example).

While generally described here, more specific features and functions will now be described in the context of a preferred user experience (UX) that may be implemented by the various illustrative components of the network environment 102 of FIG. 1. Accordingly, the following discussion may refer to particular components of the network environment 102 for context and simplicity of description. However, the preferred UX described below may also be implemented in various other ways or by alternative embodiments as well.

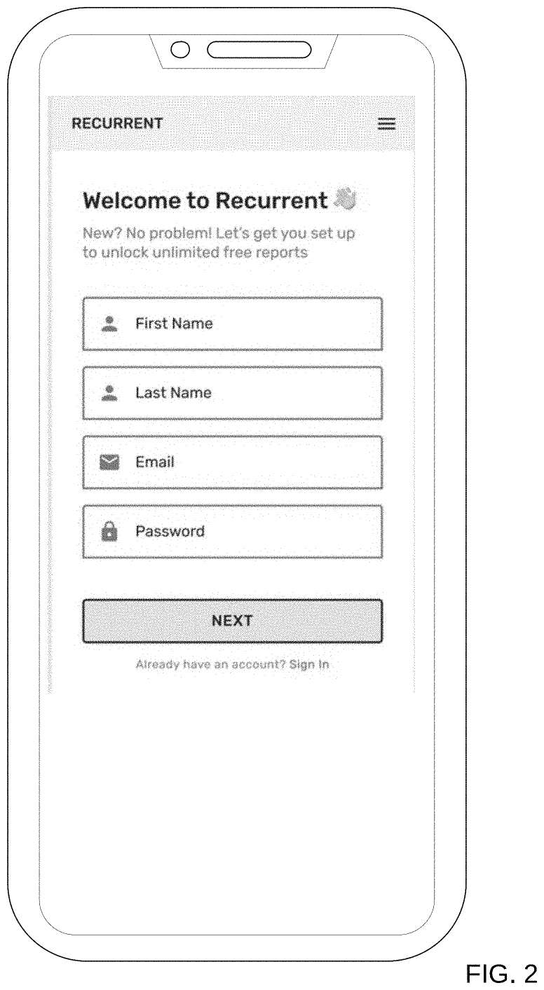

Referring to FIG. 2, a user, such as an EV owner or someone shopping for an EV, contacts the service provider 106 over the network 104 from a remote computing device (e.g., remote computing device 112 or mobile device 116) to request a condition report on a particular EV. To being, the user is presented with an initial welcome screen 200. In one preferred embodiment, the user may access the service provider 106 at the Recurrent Auto Website (www.recurrentauto.com). Preferably, the user then creates a secure account with the service provider 106, or signs in to an existing secure account. The welcome screen 200 may prompt the user for certain identifying information, such as a name and email address. The welcome screen 200 may also invite the user to provide a password to secure the user's profile or account.

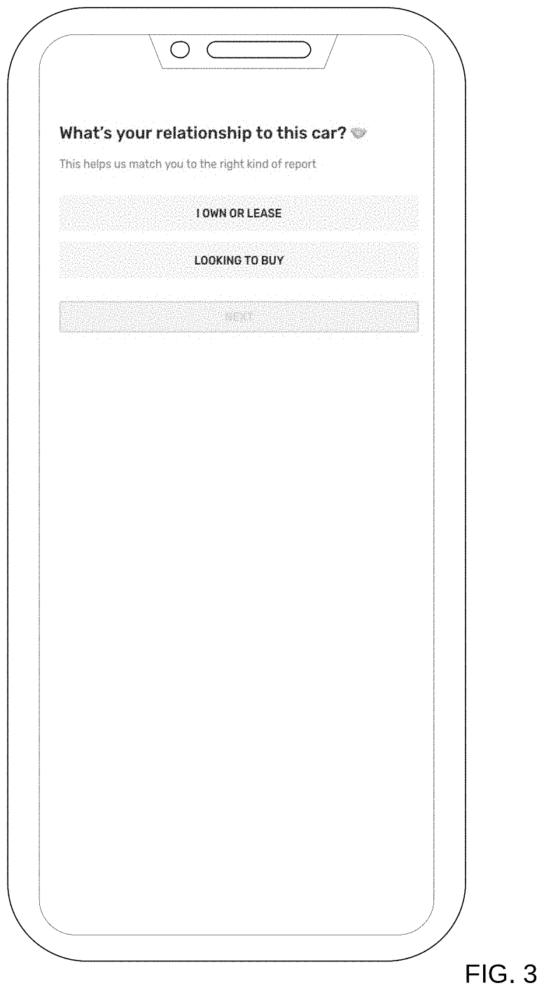

Referring to FIG. 3, the US may prompt the user to self-identify as someone who owns or leases the EV for which the user wants a report, or someone who is considering buying that EV. The user provides to the service provider 106 information about their relationship to the car. The service provider 106 may use this information to customize the report.

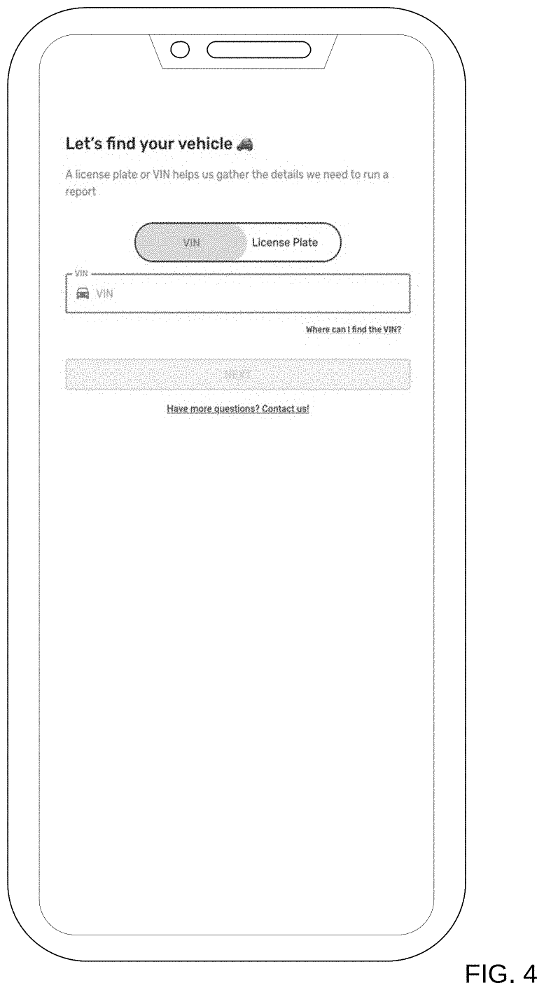

Referring to FIG. 4, the user may be presented with an identification screen 400 that allows the user to identify a specific vehicle they would like to get a report. In one option, the user may provide to the service provider 106 a unique identifier for the specific EV. In one preferred embodiment the unique identifier may be a vehicle identification number (VIN) that uniquely identifies the specific vehicle. The vehicle identification number (VIN) is a globally unique 17-character alphanumeric string that, when parsed according to industry standards can identify the make, model, year, country of manufacture and often trim level of a vehicle, along with a unique portion that distinguishes it from each other vehicle.

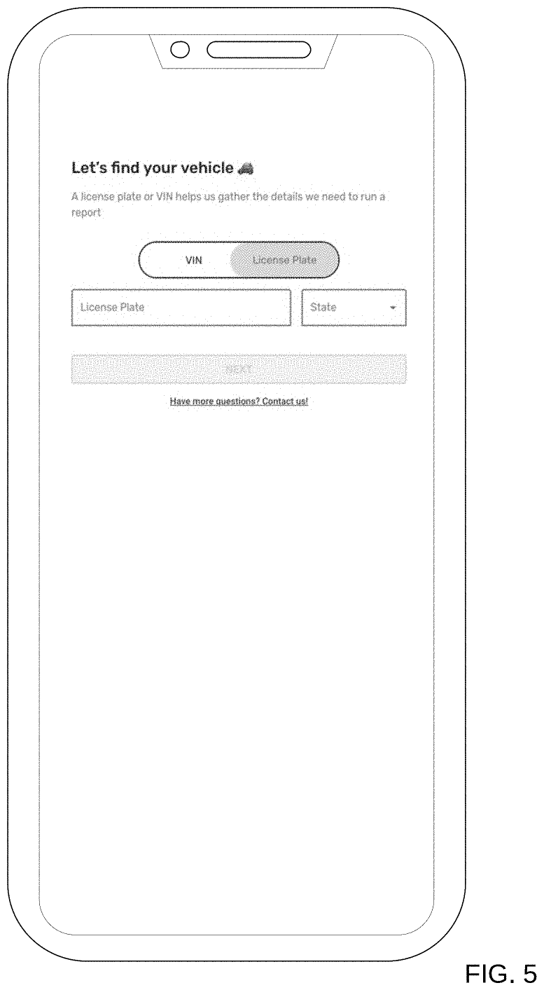

Referring to FIG. 5, the identification screen 400 may alternatively allow the user to provide a license plate number and state of registration for the specific vehicle. In such embodiments, the service provider 106 may contact a third party API (e.g., third-party data server 114) to translate the license plate number to VIN. In still another embodiment (not shown) the UX could present the user with a series of selection fields (e.g., dropdown selection boxes) that allow the user to specify exactly which EV is being considered.

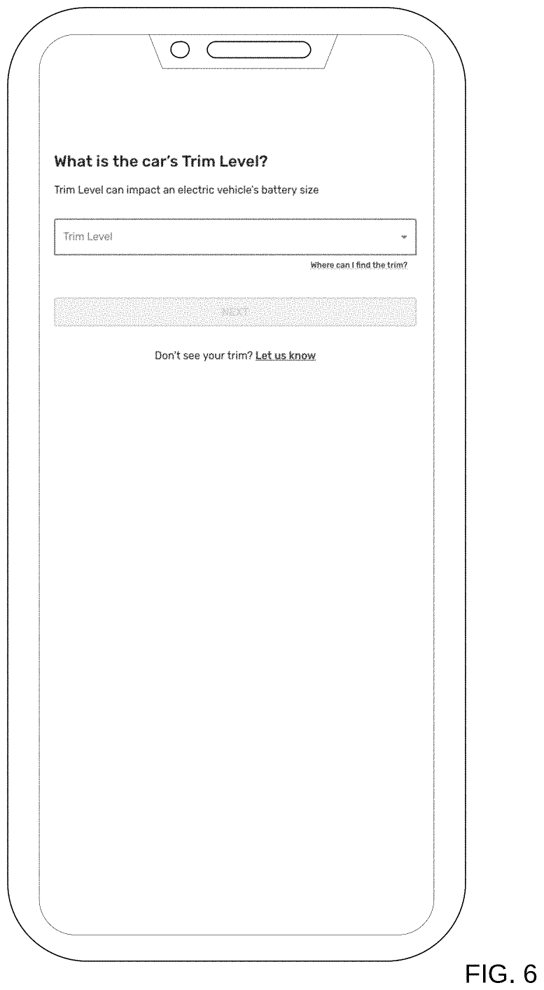

Referring to FIG. 6, the UX may prompt the user to select a “trim” level. As is known in the art, with some vehicle types (e.g., Tesla), the VIN may not contain standardized information about the trim level, so the service provider 106 may prompt the user to provide that information. The service provider 106 may also skip this step for many other EVs. The trim level for certain vehicles (e.g., Tesla) typically corresponds to battery capacity which is a direct factor for predicting range.

One aspect of the disclosure is that this feature uniquely enables the service provider 106 to capture and store in the data store 110 non-standard information for EV manufacturers (e.g., Tesla) that may not include such information as a part of the VIN data. In this way, the data store 110 can be used to provide information to potential used EV consumers that would otherwise be maintained as proprietary information by certain EV manufacturers. Such a feature has heretofore been unavailable in the industry.

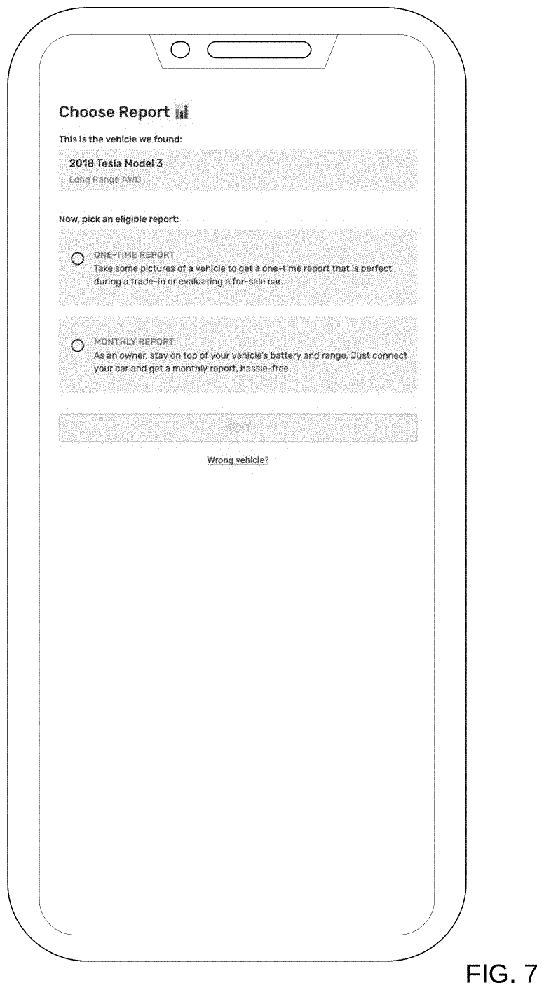

Referring now to FIG. 7, the UX presented by the service provider 106 may display the identifying information 701 for the EV, such as the vehicle's make, model, trim, and/or year based on the VIN decode. For vehicle owners with compatible vehicles, the service provider 106 may offer a choice of whether to connect their car on an ongoing basis to receive periodic reports (e.g., monthly 703) or a one-time battery report 702 based on data entered and, perhaps, photo-verified. The service provider 106 may involve another third-party data server 114, such as SmartCar, to connect, authorize and query vehicles connected on an ongoing basis. In certain embodiments, such as for users who are shopping for an EV, the screen illustrated in FIG. 7 may not be shown and a one-time battery report may be the only available option.

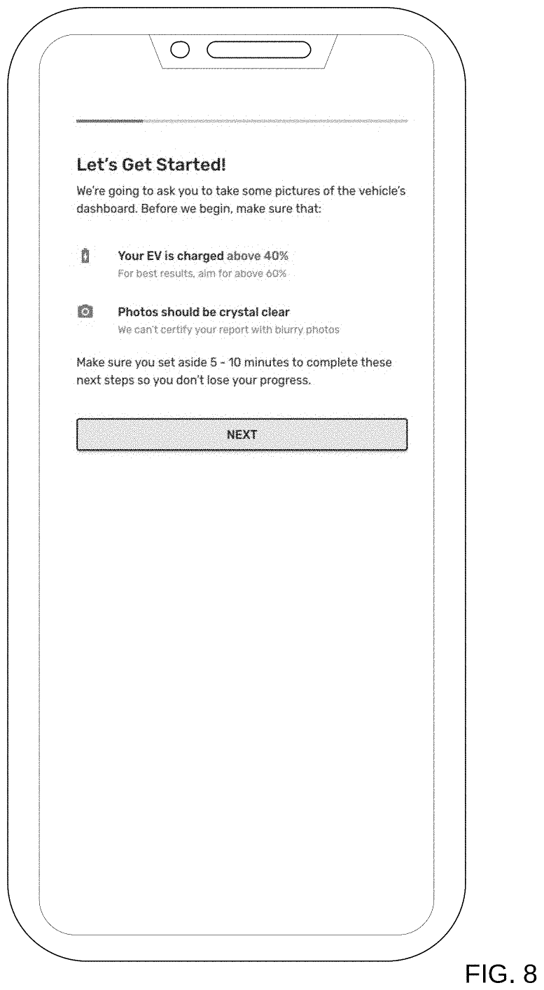

Referring to FIG. 8, the UX may inform the user about the requirements and time commitment to complete the rest of the report-generating process. For example, the user may be informed of a minimum charging level for acceptable and ideal results. The user may also be presented with any other useful information, such as a reminder that clear photographs provide the best results during the process.

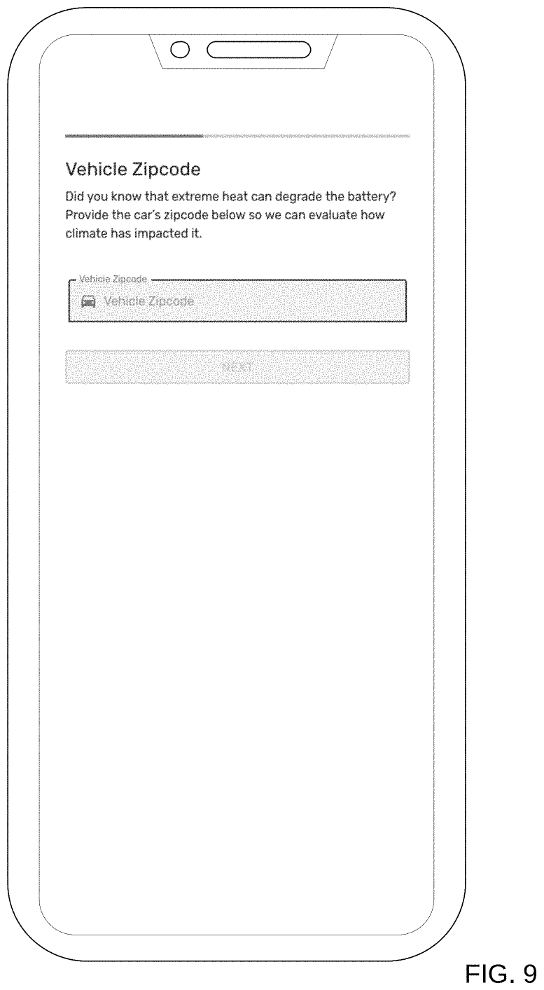

Referring to FIG. 9, the UX presented by the service provider 106 may prompt the user to input a regional descriptor 901 that can be used to determine any environmental impact that may have impacted the EV. In one example, the user may be prompted for the zip code where the EV has been used so that the this information can be correlated with temperatures for that area, to customize vehicle range estimates for the report and to predict future range and battery degradation based on possible exposure to high and low temperatures over time.

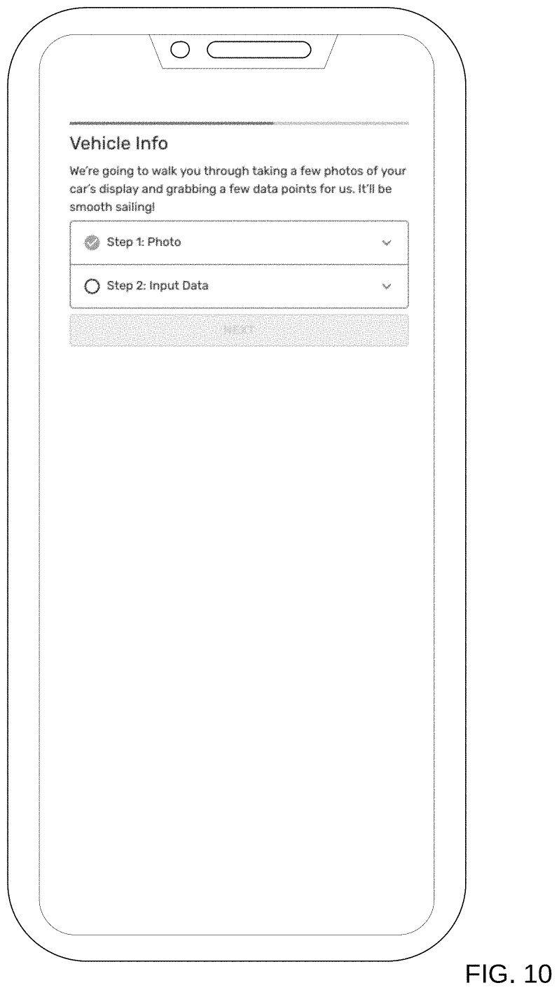

Referring now to FIG. 10, depending on the make/model/trim/year selected, the service provider 106 may prompt the user to enter specific usage and/or identification data (collectively “condition data”) that describes the EV or its components. For example, the condition data may be information that is shown on various car interfaces (e.g., digital and physical) such as odometers and battery charge indicators. Alternatively, the condition data could also be information on various stickers or other components of the EV, such as a VIN sticker or information printed on the battery pack of the EV. These and many other examples will become apparent from an understanding of this disclosure.

In one preferred embodiment, the service provider 106 prompts the user to take and upload a photo that can be used to provide specific condition data. For example, the user may be prompted to capture a photo using a mobile device 116 or other network-enabled device. Examples of the information that may be captured include the dashboard of the EV to reveal the mileage (odometer reading) of the EV, range estimates, current state of battery charge, battery capacity, and, perhaps, other maintenance features of the EV.

In another preferred embodiment, the service provider 106 may bypass capturing a photograph by prompting the user to manually enter such condition data that would otherwise be captured by photograph. In such embodiments, the UX may prompt the user with instructions for where to locate the particular data. In accordance with the disclosure, the system knows which specific data elements to request based on the EV identifying information already provided on the identification screen 400 for different makes/models/trims/years of EV that may best be used to determine that particular vehicle's range and state of health. In addition, to enhance the user experience, the system may not ask for everything and, instead, prompt the user for some subset of available condition data sufficient to prepare a condition report. Knowing what information need not be requested of the user provides a competitive advantage for embodiments of the disclosure. In still other embodiments, such combination of manual data entry and photograph-upload data entry may be employed based on various design criteria. Preferred embodiments of the disclosure have refined the specific and complicated user experience to ensure high completion rates and low error rates. This UX optimization will vary by make/model/trim and year.

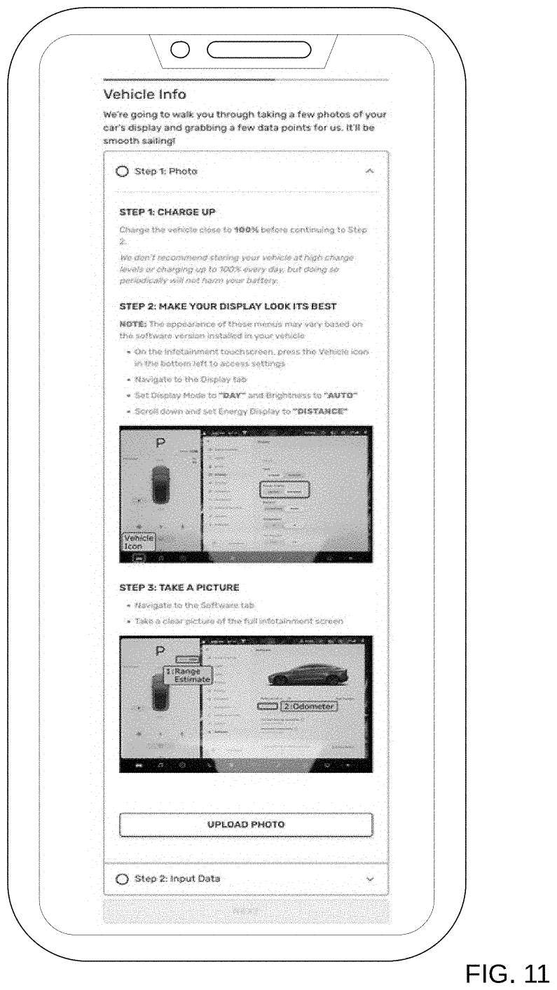

Referring now to FIG. 11, shown are example screens that the service provider 106 may employ to provide step-by-step instructions to navigate various data displays for each particular EV. For example, the service provider 106 may use the vehicle identification provided by the user to identify specific instructions for that make/model/trim/year EV so that the user may easily navigate to the correct data display to perform each data entry, and with instructions of which displays to capture by photo for verification. Typically there will be 2-3 photos per vehicle, so the user will go through a similar process several times before completing the screen shown in FIG. 11.

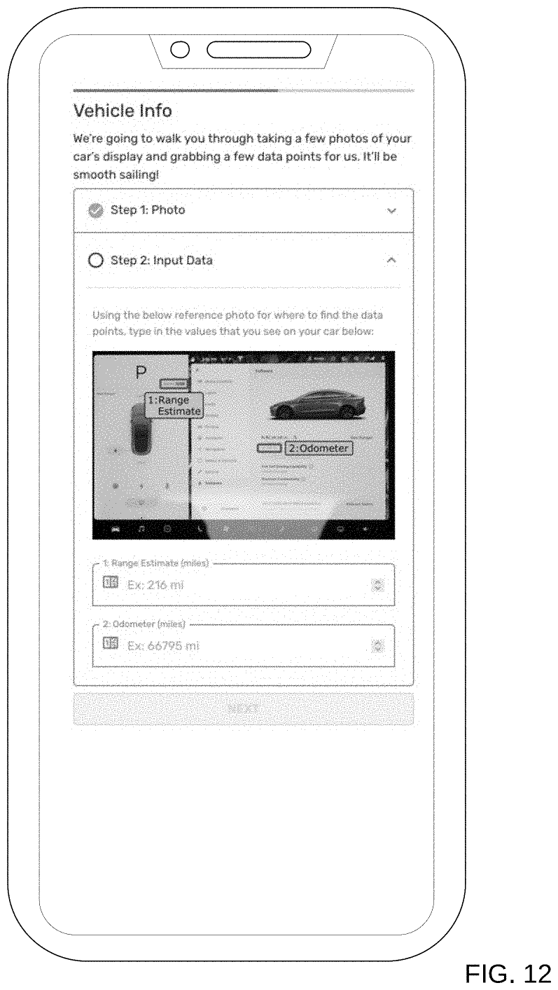

Referring now to FIG. 12, shown is an example screen where the user is asked to verify some or all of the information captured in the uploaded photos. The UX experience for verifying this information can vary by make/model/trim/year. For example, sometimes the user will be prompted to enter a number, while at other times they will drag a slider or otherwise interact with a design element which might mimic what the user sees in the vehicle itself.

The system may employ a human-powered verification process to ensure that the data entered by users matches the photos taken and uploaded by those users. Alternatively, the system may employ AI-driven photo recognition to automate this verification process, trained by the vast image database of dashboard photos and the human-provided error checking process on that image database.

Some attributes that the system may ask users to enter will not strictly be used for battery scoring. For example, (returning to the proprietary information asymmetry issue), battery pack size and install date, trim level, software-unlocked features like auto-pilot/full-self driving, transferable charging privileges and max acceleration levels may be requested. These may potentially be shown in the reports to help shoppers understand the vehicle's attributes beyond those that can be gleaned from the VIN.

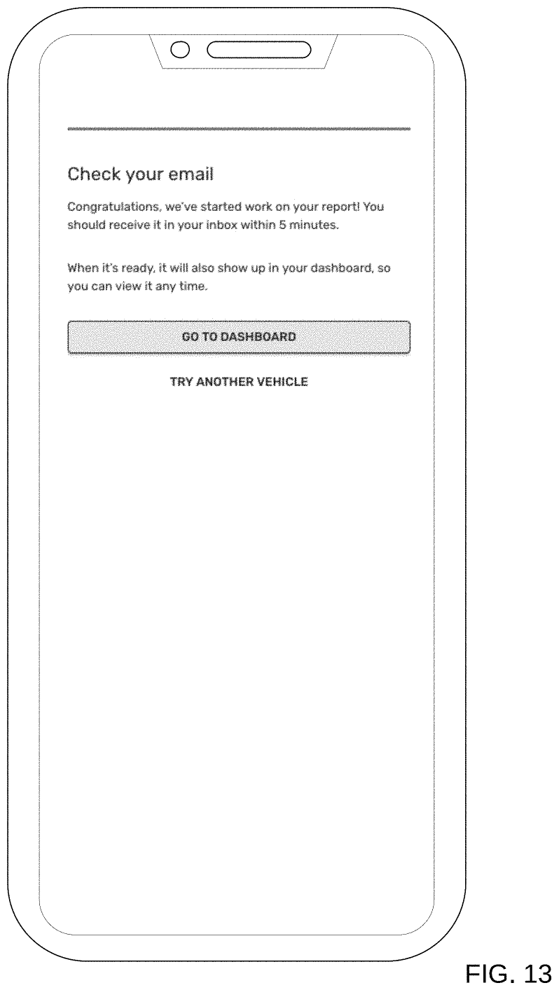

Referring now to FIG. 13, the service provider 106 notifies the user that their report is generating and will be delivered via email. The user is also provided an option to view the report in their secure account dashboard, where they also have access to any other one-time or monthly reports for all of their vehicles past and present.

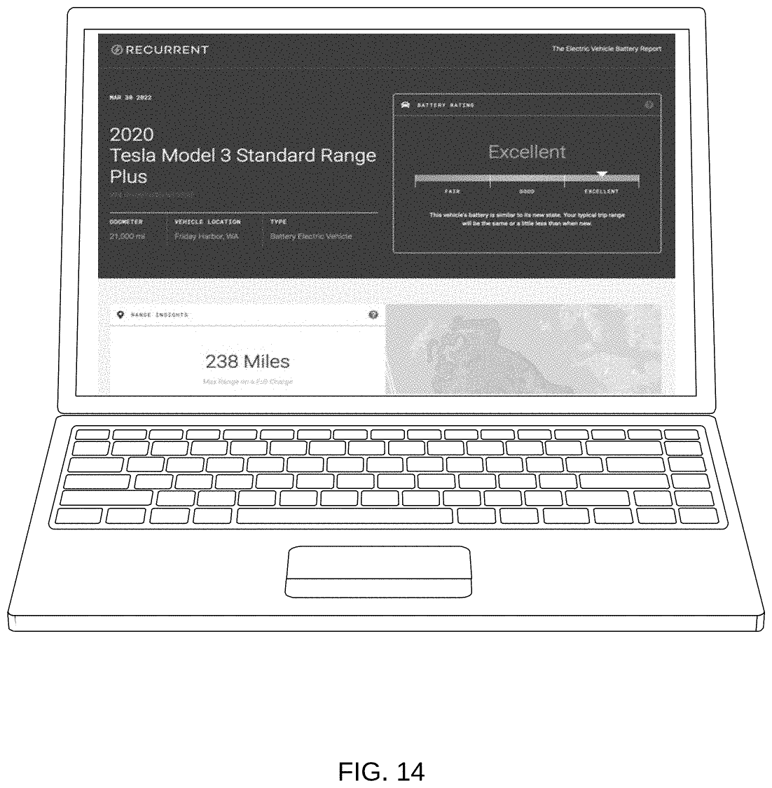

Referring now to FIG. 14, the service provider 106 may combine (1) the user-provided data inputs, (2) other data the service provider 106 can look up about the specific vehicle being scored, and (3) data on comparable vehicles to which the service provider 106 has access (e.g. similar make, model, year, trim level, location history, vehicle age, odometer history and charging patterns) to produce a report, such as the partial example battery report shown in FIG. 14.

In certain embodiments, the system may inform the health and range reporting using third party data provided by companies like Marketcheck and Experian on a vehicle-by-vehicle basis. This data might include things like: vehicle location history, battery replacements or other maintenance done on the vehicle, charging history, recall status, vehicle sales history.

For similar vehicle data, the service provider 106 may incorporate data primarily from vehicles from owners that have shared data with the service provider 106 (e.g., monthly report subscribers). In other cases, third party data that is published freely (Plug In America, EPA) or licensed for aggregate use (Flip the Fleet) may also be used.

With so many variables that differ from vehicle to vehicle, the service provider 106 employs a series of machine-learning models that are constantly evolving as the system receives new data. Roughly speaking, the score and range estimate for any given vehicle is based on an overall model of how that make/model/year/trim ages over time, modified by the individual data points entered by the user during this process or by other users or third parties previously.

Other approaches using different methods for estimating EV battery state of health may also be employed, such as plug-in diagnostics that access the vehicle's onboard diagnostic port (Auto OEM-provided tools that dealers and service centers use, or third party apps used in conjunction with plug-in diagnostic tools such as Leafspy, Torque Pro, etc.). However, these approaches involve plugging in various devices to discern the information which the previous embodiments disclosed above avoid.

Third-party apps may also be employed in conjunction with the previous embodiments where those third-party apps access vehicle-provided telematics via auto OEM APIs (e.g., TeslaFi, Tezlab, Stats for Tesla). Unlike the previous embodiments disclosed above, these third-party apps would require API connectivity to a vehicle to score its range and battery health.

After the user finishes the UX illustrated in FIGS. 2-13, and the system performs some asynchronous processing, the user is presented with a unique report on the vehicle that the user is scoring. The unique report may be provided directly by email or perhaps by web notification link. One specific example is shown in FIG. 14, but embodiments of the disclosure may generate reports that are different for different make/model/year combinations.

In yet another enhancement, the service provider 106 may offer a “Range Guarantee” based on the report estimate. In such an embodiment, the service provider 106 may offer to buy the vehicle back from an unhappy shopper (or pay a restocking fee to the dealer that sold it) if the system is wrong about the range estimates within some period of time from the purchase.

What is claimed is:

1. A method for reporting on a condition of an Electric Vehicle (EV), comprising:
prompting a user for user identification information;
prompting the user for EV identity information;
prompting the user to select from between a one-time report or a periodic report;
prompting the user to identify non-identification information related to the EV;
prompting the user to provide condition data that describes a condition of the EV;
analyzing the information and data provided by the user to prepare a condition report that describes the condition of the EV; and
presenting the condition report to the user for use in a purchase decision.

2. The method recited in claim 1, wherein the EV identification information comprises a Vehicle Identification Number (VIN) that uniquely identifies the EV.

3. The method recited in claim 1, wherein the EV identification information comprises a vehicle license plate number.

4. The method recited in claim 1, wherein the EV identification information includes one or more of a year of the EV, a make of the EV, and a model of the EV.

5. The method recited in claim 1, wherein prompting the user for EV identification information further comprises prompting the user to identify a trim level for the EV.

6. The method recited in claim 1, wherein the condition data comprises at least an odometer reading, a battery charge level, and a battery condition reading.

7. The method recited in claim 1, wherein the non-identification information comprises information about an environment in which the EV has operated.

8. The method recited in claim 7, wherein the non-identification information comprises a regional identifier.

9. The method recited in claim 8, wherein the regional identifier comprises a zip code.

10. The method recited in claim 1, wherein the step of presenting the condition report is repeated periodically when the periodic report is selected.
